(19) United States
(12) Patent Application Publication
(10) Pub. No.: US 2007/0063866 A1
(43) Pub. Date: Mar. 22, 2007

(54) Remote meter monitoring and control system

(75) Inventor: Oclayton Webb, Los Angeles, CA (US)

Correspondence Address: DARBY & DARBY P.C., P. O. BOX 5257, NEW YORK, NY, 10150-5257, US

(73) Assignee: Andisa Technologies, Inc., Los Angeles, CA (US)

(21) Appl. No.: 11/497,561

(22) Filed: Aug. 1, 2006

Related U.S. Application Data
(63) Continuation of application No. PCT/US06/21568, filed on Jun. 2, 2006.
(60) Provisional application No. 60/687,468, filed on Jun. 2, 2005.

(51) Int. Cl. G08C 15/06; G08B 23/00

(52) U.S. Cl. 340/870.02

(57) ABSTRACT

An automated server based system for monitoring, reading, controlling as well as switching gases, liquids and electric power is provided for use in remote Automated Meter Reading (AMR) industry for water, gas and electric power utilities, Supervisory Control and Data Acquisition (SCADA); Security, Safety and Fire Alarm Systems (SSFA) and Home and Industrial Automation (HIA), in connection with appliances and equipment of all kinds.

This application claims the benefit of priority under 35 U.S.C. §119(e) of U.S. Application Ser. No. 60/687,468, filed Jun. 2, 2005, and is a continuation of International Patent Application No. PCT/US06/21568 filed Jun. 2, 2006, both applications entitled, “Remote Meter Monitoring And Control System,” which is hereby incorporated by reference in its entirety.

### FIELD OF THE INVENTION

The present invention relates to the remote monitoring and control of meters, such as meters for tracking utility usage and the like.

### BACKGROUND OF THE INVENTION

The monitoring, reading and controlling as well as switching of a myriad of devices and equipment has been traditionally accomplished with Remote Terminal Units (RTU), Programmable Logic Controllers (PLC) and a host of other proprietary systems. All of these proprietary systems are part of Supervisory Control and Data Acquisition Systems (SCADA). Conventional SCADA systems are highly centralized.

Monitoring, reading, data storage and control limitations have been especially true for the automated utility meter reading industry.

The automated meter reading industry began with employees visually inspecting electric and gas meters and entering the data into a hand held computer for later downloading upon return to the utility's offices. Hand held and mobile systems use radio equipped vans that drive by houses and/or businesses collecting readings from meters that are retrofitted with conversion subsystems. However, these systems have more limited functionality in terms of what services can be offered.

As early as 1991, the needs of the utility industry were changing, as a result, industry participants realized that business would rapidly decline and fail without Fixed Network Automated Meter Reading (AMR) technology. Fixed Network AMR provides for automatically reading meters via a fixed communications network, enabling many new enhanced functions, such as real-time meter reading, Time-Of-Use (TOU) meter reading, and outage alarms. These enhanced functions would necessarily include the ability to permit hourly meter readings, as will soon be specifically required of utilities by government regulators, and in general required to be competitive in the new operating environment, resulting from the significant changes in utilities regulation.

Because of the specific demands of government regulators, as well as the general competitive demands of the marketplace, the many capabilities promised by Fixed Network AMR will render obsolete, monthly hand held and/or Mobile AMR meter reading. In particular, the Fixed Network AMR would largely replace, and therefore largely eliminate, the market for hand-held and mobile AMR meter readings systems.

Also, as early as 1992, it was observed that a number of existing potential competitors were making rapid progress in developing Fixed Network AMR systems. These competitors

Yet another problem with the polling design is its inability to handle alarm system functions. Because hand-held and Mobile AMR meter readings systems must be “awakened” in order to send data, they cannot send an outage alarm.

Moreover, interference and insufficient signal strength results in many remote device transmission failures, even in the absence of an outage, so there is no way to know whether the failure of remote device response is actually from an outage. In short, the polling design of the hand-held and mobile AMR meter reading systems prevents the alarm function from being performed at commercially acceptable levels.

Hand-held and mobile AMR meter readings systems must first wait until they receive a “wake-up” signal which means that there is no reliable way for the network to know at any given time that there is an outage at the meter. The alternative is to wake-up all units every few seconds, and assume there is an outage if a particular remote device does not respond to its wake-up call.

The present invention addresses these and other problems, and provides a solution with applicability in mulitple markets for utilty and information services.

### SUMMARY OF THE INVENTION

In accordance with one aspect of the invention, a distributed automated system for monitoring, control, or both of a device, comprises a centralized automated server (CAS), one or more local automated servers (LAS) in data communication with the CAS, each LAS including a microprocessor and memory configured to analyze data provided thereto, one or more intelligent nodes remote from each LAS, a module associated with each intelligent node, the module being in communication with said node, the module interfacing with the device and providing data from the device to the LAS via a respective node, and software executing on each of the CAS and the LAS, the software configured to store and process information from each node at one or more of the LAS and the CAS and to selectively execute a local control operation on the device via communication through the respective module and node.

A Centralized Automated Server (CAS) system communicates with an interface unit that is connected via metering devices to an appliance or any equipment that can be monitored and/or controlled. Said appliance and/or equipment will be locally (remotely) monitored, read and/or controlled by a Local Automated Server (LAS). The central server can program or operate the appliances and equipment through its communication with the local severs. Each local server is connected and communicates with local nodes, connected to any device to be monitored and controlled. Each local node consists of an interface transducer to convert analog information to digital data. The conversion can include analog-to-digital conversion, digital-to-analog conversion and frequency-to-voltage conversion, for example. The digital data is uploaded to the remote local server. Each node is connected to and communicates with intelligent modules. The data is stored in the local server and analyzed based on pre-programmed instructions and data. All information communicated and analyzed by the local servers are in turn uploaded to the centralized servers for backup storage and further analysis, based on the entire facility or system characteristics and parameters. The centralized or local servers can selectively execute a local control operation to any appliance or equipment via local nodes, modules and interface units. In addition, each node can act as a fully integrated system to prioritize the operation of any appliance or equipment for the most efficient and effective operation of the residential home, commercial factory or facility. If required, any of the mediums—gas, liquids and electric power can be switch to a compatible medium of a similar kind to continue operation of the aforementioned appliances or equipment, all based on pre-programmed instructions.

The invention can be more completely understood with reference to the accompanying drawing figures and description of certain embodiments thereof.

### BRIEF DESCRIPTION OF THE DRAWING FIGURES

FIG. 1 is a block diagram of the interconnectivity of a system in accordance with the invention. Among the blocks, there can be one or more Local Automated Servers (LAS) connected as illustrated to remote nodes and to Centralized Automated Servers (CAS).

FIG. 2 shows a Central Facility having multiple CASs, though other Central Facilities can have fewer (e.g., one) or more CAS s.

FIG. 3 illustrates an exemplary CAS connected to transceivers as part of a Fixed Communication infrastructure.

FIG. 4 is a block diagram of a remote location, showing several Nodes including an exemplary Node in detail.

FIG. 5A is a block diagream of an exemplary LAS connected to an exemplary Node.

FIG. 5B is a block diagram showing the exemplary Node of FIG. 5A connected to several modules, though it could be connected to fewer modules (e.g., one). The modules connect and control gas meters and gas valves; power meters and circuit breakers; and water meters and water valves. For electric power service, the nodes may control electricity sources such gas electric generators, solar photovoltaic systems, wind electric generators, and the like. For water service, the nodes may control alternative water sources. Further, a gas service node may control bio-gas, hydrogen gas and propane gas.

FIG. 6 shows an exemplary Node for controlling Home/Office Appliances and Industrial/Commercial Equipment.

### ACRONYMS USED IN THIS DOCUMENT

The written description of the present invention uses acronyms to describe various systems, components and services. For the purposes of the written description herein, a few of the acronyms are defined as listed below:
AGICS—Andisa Galaxy information and Control System
AMR—Automated Meter Reading
CAS—Centralized Automated Server
CCU—Coalition of California Utility Employees
EDI—Electronic Data Exchange
EEPROM—Electrically Erasable Programmable Read Only Memory
ESP—Energy Service Provider
HIA—Home and Industrial Automation
IAEI—Intemational Association of Electrical Inspectors
LAS—Local Automated Server
MDMA—Meter Data Management Agent
MSP—Meter Service Provider
OO—Object Oriented
ORPA—Office of Rate Payer Advocates
PSWG—Permanent Standards Working Group
PWM—Pulse Width Modulation, as in a PWM Switching Transistor
RTU—Remote Terminal Unit
SCADA—Supervisory Control and Data Acquisition
SSFA—Security Safety and Fire Alarm
TDMA—Time Division Multiple Access
TOU—Time of Use
UDC—Utility Distribution Companies
VEE—Validating, Editing and Estimating

### DETAILED DESCRIPTION OF CERTAIN EMBODIMENTS

### INTRODUCTION

Utilities that have deployed wireless radio networks tend to focus on near-term improvements in their operations to reduce their rates. These utilities are using wireless networks to offer customers services like automated meter reading services; time-of-use rates, in which customers pay less for electricity when overall electric demand is lower; as well as energy information services, which help customers make energy-efficient choices by telling them how much energy each of their appliances is using.

The present invention offers a unique method of monitoring and controlling appliances and equipment by its multi-communication methods and its ability for peer-to-peer information exchange. included Metricom Inc.; Schlumberger, Inc.; Itron, Inc; CellNet Data Systems, Inc.; and a joint venture of General Electric Corporation and Ericsson.

A reason hand-held and mobile AMR meter reading systems are not suitable for operation in competition with Fixed Network AMR is that they operate via polling. This means that it sends data only after first being “awakened” by a radio signal sent from the transmitter/receiver or the collection unit (whether carried by the meter reader or mounted on a vehicle).

A problem with the polling design of hand-held and mobile AMR meter readings systems, is that it is unsuitable for use in competition with Fixed Network AMR. Multiple units responding simultaneously to a wake-up signal cause data transmissions to cancel one another. Only some of the transmissions are successful with moving receivers, as discussed above.

With moving receivers, successive transmissions of wake-up signals from continuously changing locations results in more or less reliable transmission of data. Unlike fixed receivers, the same signals continuously cancel one another, resulting in unreliable and commercially unacceptable transmission.

Another problem with the polling versus fixed network approaches, is that there is no redundancy of information. This makes time-of-use meter reading and hourly meter reading unreliable, since loss of some transmissions means loss of data. If one data transmission from a remote device is lost, that data is lost forever. The result is that the time-of-use and hourly data is not usable for billing by utilities.

Wireless radio technologies are further along in terms of large-scale deployment, compared to competing communications systems. However, the utilities involved in broadband cable development appear to be eager to get involved in the burgeoning home-based information, entertainment and communications market. Many utilities plan to offer non-energy services such as electronic home security and personal communications. The present invention makes it possible to compete in all those markets as well as addresses the needs of both the home security and personal communications.

Utilities that own cost data indicate that wireless radio systems are considerably cheaper than hybrid fiber-coax cable (broadband) systems. One-way mobile wireless systems cost about $100 to $150 per house installation. These use radio-equipped vans that drive by houses, collecting meter readings from utility meters retrofitted with utility modules. However, these systems have more limited functionality in terms of types of services that can be offered. As for fixed wireless networks, they cost utilities between $180 and $600 per house to install. These systems usually have a two-way radio network from the local pole-top collector back to a central utility location, rather than all the way to the customer premise. Finally, broadband cable projects were currently the most expensive, costing between $1,000 and $3,000 per house, according to market surveys taken in the year 2000 AMR publication known as the Scott Report.

The mobile receiver approach suffers the significant disadvantage of being effectively unidirectional; thus, communication cannot be initiated from the utility's central office. Therefore, systems of this type have limited functionality and relatively low feature/function cost ratios and are not well suited for use by utilities. The cable television communication approach uses existing cable television lines to transmit data. Some tests have shown that this may be a cumbersome and expensive approach, but some municipal utilities that own cable systems are undertaking this type of communication. Additionally, many installed cable systems are not configured to pass signals from the subscriber's site to a central facility. Cable television should not be discounted. Moreover, as a viable communications medium, several municipal electric utilities have purchased their local cable companies and upgraded systems consistent with the needs of AMR. If the cable companies sell AMR services to local electric, gas and water utilities, the aforementioned approach can prove very viable. Future advances in cable will include bi-directional digital signal transmission and much wider bandwidth ultimately using fiber optics at which point cable will be an ideal communications medium.

Utilities that have deployed wireless radio networks tend to focus on near-term improvements in their operations to reduce their rates. These utilities are using wireless networks to offer customers services like automated meter reading services; time-of-use rates, in which customers pay less for electricity when overall electric demand is lower; as well as energy information services, which help customers make energy-efficient choices by telling them how much energy each of their appliances are using. Wireless radio technologies are farther along in terms of large-scale deployment, compared to competing communication systems. The utilities involved in broadband cable development appear to be eager to get involved in the burgeoning home-based information, entertainment and communications market.

The full-scale implementation of AMR requires that a data communication network be established that effectively links every utility customer with the utility's central office. The actual amount of AMR related data and its frequency of transmission is very low. These factors contribute to the difficulties encountered in the economic justification of AMR systems. There are, however, a myriad of services and functions that can be accomplished through this communication system, some of which significantly reduce a utility's operating cost and actually generate additional revenues. The incremental costs associated with incorporating these functions in the AMR system controllers can be substantial. Payback can vary enormously. The present invention provides for a full-scale implementation of AMR requirements, with its total systems design solution, and resolves the future problems faced by the AMR industry. The invention also offers its adopters a way to amortize cost by providing additional service to their customers. In theory, it may be possible to finance a full-scale AMR system installation through the resulting costs savings and new revenue-producing services.

Often, one of the key elements of system consideration is the communications methodology that is utilized to remotely access meter data according to information as reported by Howard Scott's market report for the year 2000. The Scott report (an AMR industry report) indicates that radio frequency (RF) communications is clearly the dominant choice for AMR in today's market. However, to be cost effective for the upcoming future, usage of a full array of communication methodologies should now be considered to maintain competitiveness. In fact, radio technologies are ahead of cable-based broadband communications in electric utility market tests of electronic information services for residential customers, according to a new study from the Ernest Orlando Lawrence Berkeley National Laboratory. Utilities are racing into this potentially lucrative market in search of new sources of revenue as many States consider deregulating utility markets and introducing retail competition.

The advantages of the present invention are readily demonstrated within the environment of deregulation of all utility, including the phone utility. Under deregulation, the end user customer will be able to select his or her own utility service providers. In fact, the California Utilities Commission, has mandated the requirements for collecting and publishing data for electric utilities; through its Meter Data Management Agent (MDMA), which was initiated in the year 1998. The deregulation practices of the electric utilities committees requires that settlement quality data be provided to multiple business entities including the ESP, the UDC and other third party business entities. Interim meter and meter data standards were initially adopted in Decision (D.) 97-10-087 and (D.) 97-12-048. Today's decision addresses the recommendations for permanent standards which were contained in the workshop report filed by the Permanent Standards Working Group (PSWG). Among the permanent standards, the following were adopted: meter product standards; certification testing requirements that meter products must comply with; and the submission to the Energy Division of the meter type self-certification document.

The procedures to follow for rebuilding, retrofitting, or repairing meter products include:

Meter communication standards including KYZ contact outputs, and the requirement that a direct access meter have a localized visual kilowatt-hour (kWh) display or a physical interface to enable on-site interrogation of all stored meter data.

Meter data management and meter reading standards. These include standards for meter data management agents (MDMAs), including how often a meter is to be read, safety requirements, timeliness of validated meter data, and exemptions from having to timely make meter data available.

An order that the utility distribution companies (UDCs), electric service providers (ESPs) and MDMAs move toward using Electronic Data Interchange (EDI) standards to transfer meter usage information in accordance with the schedule discussed in the decision, and that the Direct Access Tariff Review Committee file a report with its recommendations for implementing EDI on a statewide basis.

Validating, editing and estimating (VEE) rules for meter data, and an order that a workshop be convened to work on additional VEE issues.

Meter installation, maintenance, testing and calibration standards. This includes the schedules for the maintenance and testing of meters, meter test procedures, and the calibration and maintenance of test standards.

Meter worker classifications and, as an interim measure, an order placing the burden on the ESPs to prove that the meter service providers (MSPs) are capable of performing the meter work in the various classifications should any questions arise. Explore what permanent entity should eventually administer and design the meter worker certification tests. The MSP certification process was streamlined by eliminating the 50 joint meet and log requirements, and the provisional certification process.

Comments to the Workshop Report were filed by the California Energy Commission (CEC), Coalition of California Utility Employees (CCCUE), Pacific Gas and Electric Company (PG&E), and Southern California Edison Company (SCE).

Joint comments to the Workshop Report were filed by the Electric Power Research Institute (EPRI), the Institute of Electrical and Electronics Engineers (IEEE) Standards Coordinating Committee 31 (SCC31), and the Office of Ratepayer Advocates (ORA). In addition, the Executive Board of the Southern California Chapter of the International Association of Electrical Inspectors (IAEI) submitted a Sep. 25, 1997 letter in response to the Workshop Report.

Most AMR systems cannot meet the above new demands of the deregulated market place, worldwide. Further, the conventional AMR providers do not meet all the needs of the customer by providing daily/hourly usage and their ability to impact this usage to minimize consumption and monitor their total energy and water requirements. Some other needs of the customer are to be able to switch their principal electric, gas and/or water service to a similar kind of medium. In the case of electric service, an exemplary embodiment of the present invention can switch from the normal electrical grid system to a solar photovoltaic, gas generator set, and/or wind generator, among others. Further, the present invention can also provide for generating electricity back into the grid system, thus producing a dollar refund from the electric service providers. For Automated Meter Reading; Supervising Controls And Data Acquisition and Security, Safety and Fire Alarm Systems as well as a host of many other market sector systems, the present invention offers revolutionary methods of monitoring, reading and controlling information flow and control execution

All of the aforementioned systems feature wireless communication, which will soon dominate in their respective market areas. One reason that wireless may dominate in the market for residential customer energy information services, is that its installation cost per house is currently much cheaper than that of cable-based systems,long distance telephone, cable TV service and Internet connectivity. Currently, utilities are testing out different approaches, and most are offering these services to customers in pilot programs for free, but this will not continue. It is expected that a small number of big winners will emerge from these trials, probably four to seven leading firms that act as system integrators for teams of product vendors, meter companies, communications and software firms. Most of the information compiled in market surveys involve one of four technology types: broadband cable-based networks, fixed wireless radio networks, mobile wireless systems, or telephone-based systems. Many utility companies involved in broadband projects seek to become full-service retail providers of energy and non-energy services. These utility companies view both as potential sources of revenue.

The present invention's capability for use in multiple markets is more advanced than any other system to date.

Since 1991, fixed network type Automated Meter Reading (AMR) Systems have become the most popular method of transmitting information from the remote meters to a host computer. A major limitation of interacting with the present AMR systems is that there is a lack of flexibility, because as described previously, different modes of communication between the remote meter and the host computer have recently become feasible. In addition, since there is an increasing need to read meters on a daily and hourly basis, the limitation of monthly readings has become inadequate. Both the end user and the service provider need to know daily and hourly utility usage readings to lower cost; determine load profiles; as well as provide tampering outage features and monitor the quality of the gas, power or water that is provided. Moreover, even a more important limitation is the increasing needs of the end user and energy providers to enable these two principals to monitor the billing, energy management and supervisory control over all of these functions. Usually separate systems are used to monitor billing and energy management as well as supervise the control action. Some of the most recent designs have sought to address these limitations by utilizing a high level of distributing task at the central data facility.

One of these designs is reflected in U.S. Pat. No. 6,08,659. Although this is the most sophisticated information collecting process for AMR Systems since its patent date of introduction in May 1998, it still has limitations. Its major limitation is that it is highly centralized and distribute information tasks, such as data storage, billing and execution of control at the central facility, divided among several host computer servers. The above design is a distributed system. However, the distribution occurs at the central facility's host computers. Thus, the automated meter-reading servers proposed in the '659 patent lack devices to directly monitor, read, process or control the information at the remote site location. On the other hand, the present invention addresses the limitations of the '659 patent by offering a true distributed methodology at both the central and local levels.

There does not seem to be any distribution of automated reading task executed at the remote site and then uploaded to the central servers. Most of the information is collected at the remote sites and thus data transits through the traditional proprietary meter reading equipment and uploads this data directly to the central facility's automated servers.

Moreover, all of the data collected at the site has to be relayed or uploaded to the central facility's automated set of servers for decisions regarding billing, power outage and data storage. Although this automated meter reading system is an open system and has the design capability to read a myriad of proprietary meter readers for different companies, it lacks the ability to process this information and data remotely and transfer the processed information/data within a later time frame.

Additionally, meter reading capabilities are described in U.S. Pat. No. 4,008,458 and U.S. Pat. No. 4,135,181. These two patents have their own limitations. The '458 patent requires polling features, while '181 patent lacks a local remote capability to store and control the process. Both patents must initiate commands from the central station only. By contrast, the present invention provides for a total automated meter reading solution as well as a system that can interface with other vendors' proprietary systems that are existing remotely at the meter or systems not yet installed.

In one exemplary embodiment, a system in accordance with the invention utilizes local automated servers to store information in RAM and also in the 1½ inch larger data storage device. This means data and information can be stored at the customer's premise, resulting in a low loss of data as well as a method that ensures that lost data previously transmitted, can be recovered and re-transmitted within a convenient timeframe.

The invention also provides for a fixed networked system that can be enhanced by adding WI-Fl capabilities.

Further, given that many utility companies involved in broadband projects seek to become full-service retail providers of energy and non-energy services, as both services asre perceived as potential sources of revenue, the present invention can be used to compete in most of these energy and non-energy markets.

### DISCUSSION

In an exemplary embodiment, the components of SCADA systems can be replaced in accordance with the present invention to decentralize at the central station and provide a truly distributed system across remote sites. In an aspect of the present invention, central as well as local automated severs with an extensive database mapping system using object as well as relational database strategies are employed. These server systems act as a more sophisticated and versatile method of collecting, storing and processing data, as described next.

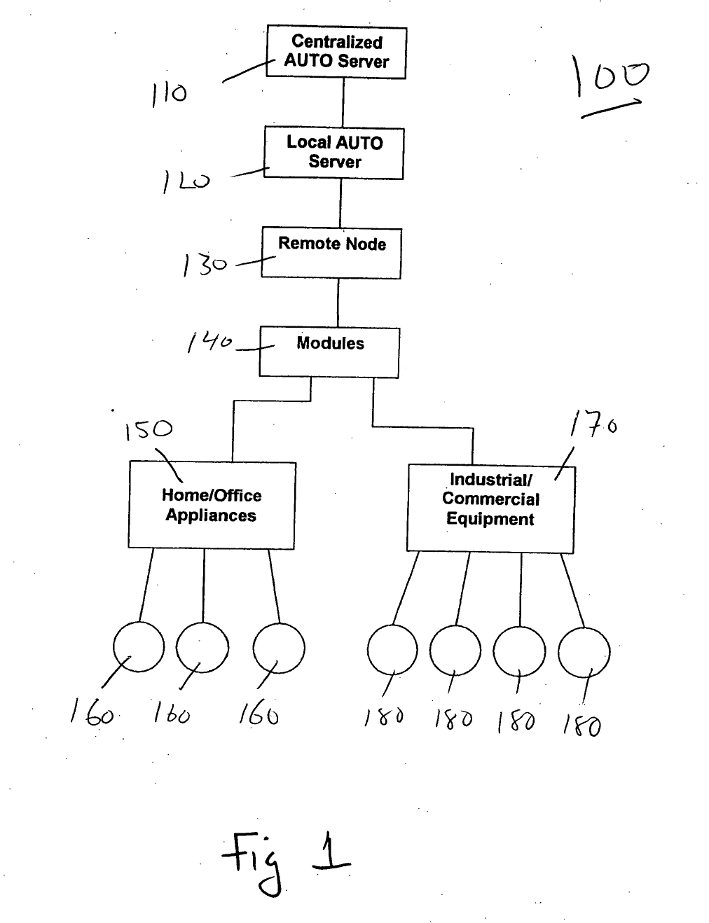

Referring now to FIG. 1, an exemplary system 100 in accordance with the present invention significantly lowers the cost for the above communication methods by using a Centralized Automated Servers (CAS) 110 and Local Automated Servers (LAS) 120 which are designed with enough capability to store and process a huge amount of information, thus utilizing less of all the available communication modes as well as requiring less frequent transmissions. In addition, because of the capability to store and process information at the LAS and also at remote nodes 130 and modules 140, a minimum amount of data communication between the CAS 110 and the LAS 120 is necessary. As described herein, the system 100 provides uses central servers 110, local servers 120, which are installed at the meter site and in data communication with the central server, and interface devices at the meter (described below) to process and control down line functions. The down line functions include home appliances; home/commercial equipment; meter mediums such as gas, water and electricity.

In the exemplary embodiments of the present invention, a local automated server 120 is provided at the site of data gathering, also referred to herein as the “meter site.” In addition, the local server communicates and is physically connected to intelligent nodes 130. The nodes 130 comprise interface devices that can be constructed to measure either analog or digital information or both, perform signal conditioning, and perform signal processing. The nodes also store information and communicate this information to the local automated server 120, optionally without first being polled by the LAS 120. The nodes are distinct and hence remote from each LAS.

The LAS 120 operates as a local, onsite monitoring, reading, information/data storage and processor of information uploaded from the nodes 130. The LAS 120 can utilize conventional communication protocols such as TCP/IP to communicate information between nodes 130 and the CAS 110. Proprietary communcation protocols can also be accomodated and translated into other communicaiton protocols for communication throughout the system 100. Communications among control devices are known to those of skill in the art, and can include open protocols and proprietary protocols such as BACNET, MODBUS, LONWORKS and OVERLAY PROCESS CONTROL (OPC) communication protocols. Using a protocol appropriate for the node being monitored, the LAS 120 can read or monitor communications from the node and store that information for communication to the CAS 110.

The advantages of the present invention is readily demonstrated within the environment of deregulation of all utility, including the phone utility. Most AMR systems cannot meet the new demands of the deregulated market place, worldwide. Further, the conventional AMR providers do not meet all of the needs of the customer by providing daily/hourly usage and their ability to impact this usage to minimize consumption and monitor their total energy and water requirements. Some other needs of the customer are to be able to switch their principal electric, gas and/or water service to a similar kind of medium. In the case of electric service, the present invention can switch from the normal electrical grid system to a solar photovoltaic, gas generator set and/or wind generator. Further, the present invention provides for generating electricity back into the grid system, thus producing dollar refunds from the electric provider.

The many limitations imposed by conventional AMR as well as some of the most recent designs are a clear indication that the present invitation meets the needs or requirements of a diverse and growing market place. For Automated Meter Readings Supervising Controls And Data Acquisition and Security, Safety and Fire Alarm Systems as well as a host of many other markets, the present invention offers revolutionary methods of monitoring, reading and controlling information flow and control execution. In lieu of the limitations and upcoming needs and requirements of the utility industry; the SCADA industry as well as the Security, Safety and Fire Alarm markets, the present invention, as described herein more than meets the needs of these markets and also provides more features unforeseen for the future of automating a diverse number of systems. The present invention can serve, for example, the AMR, SCADA, SSFA and Home/Industrial Automation markets. It will enable automated systems to monitor read, control and switch gases, liquids and electrical power as well as collect, convert and process information parameters. The system presents a total solution for the markets described within this patent application.

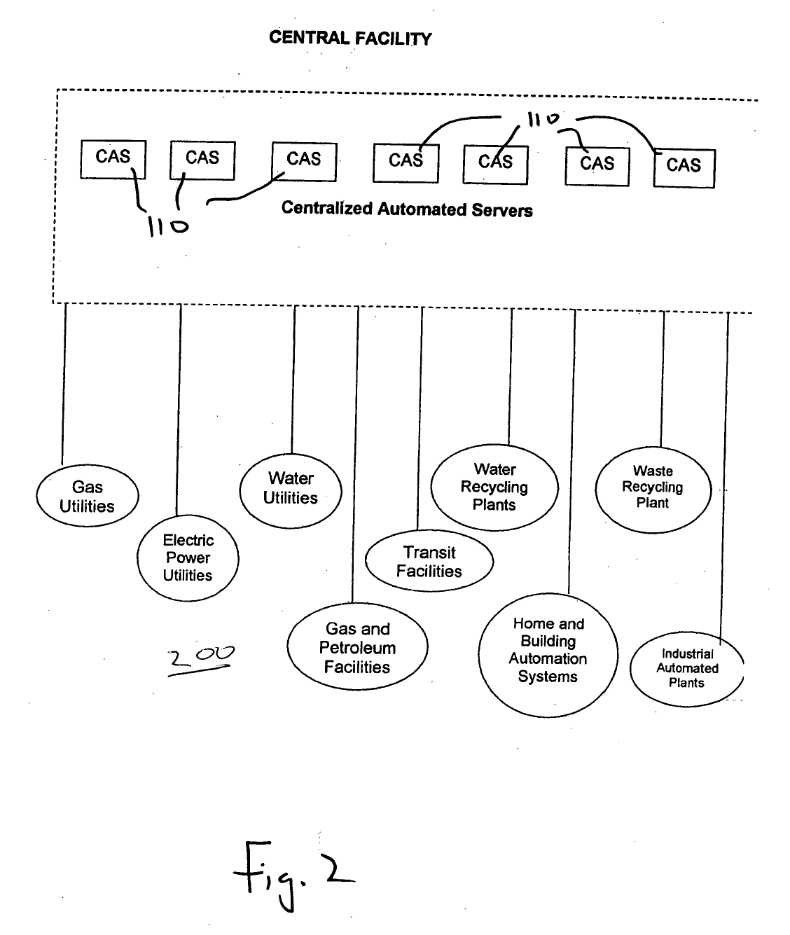

FIG. 2 shows some of the major markets that can be served as a Central Facility 200 operating an automated server-based system such as central servers 110. Those markets include:
1. Gas Utilities
2. Electric Power Utilities
3. Water Utilities
4. Water Treatment Plants
5. Gas and Petroleum Facilities
6. Transit Facilities
7. Water Reclamation Plants
8. Home and Building Automation Systems 9. Traffic Control Systems
10. Waste Recycling Facilities
11. Industrial Automation Plants

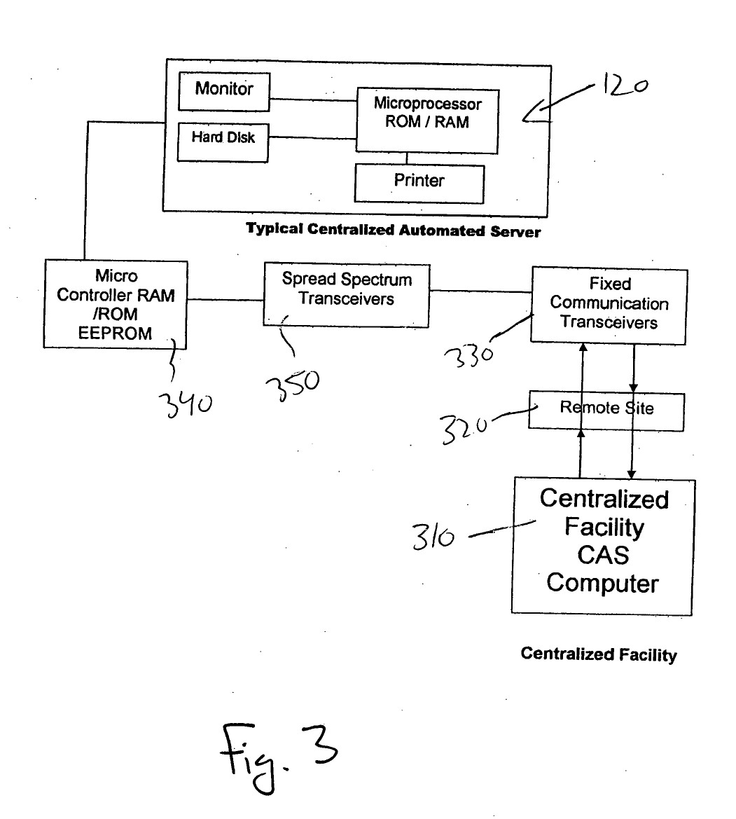

In FIG. 3, a Central Facility CAS computer system 310 communicates with a remote site 320 using fixed communication transceivers 330. An LAS 120 communicates with micro controllers 340 which provide monitiored signals from monitored and/or controlable devices. As illustrated, spread spectrum transceivers 350 couple the microcontrollers 340 to fixed communication transceivers 330. The LAS 120 itself can be a conventional computer having a microprocessor, ROM, RAM, mass storage such as a hard-disk drive, and periperhals such as a monitor, printer and input devices (e.g., keyboard, mouse).

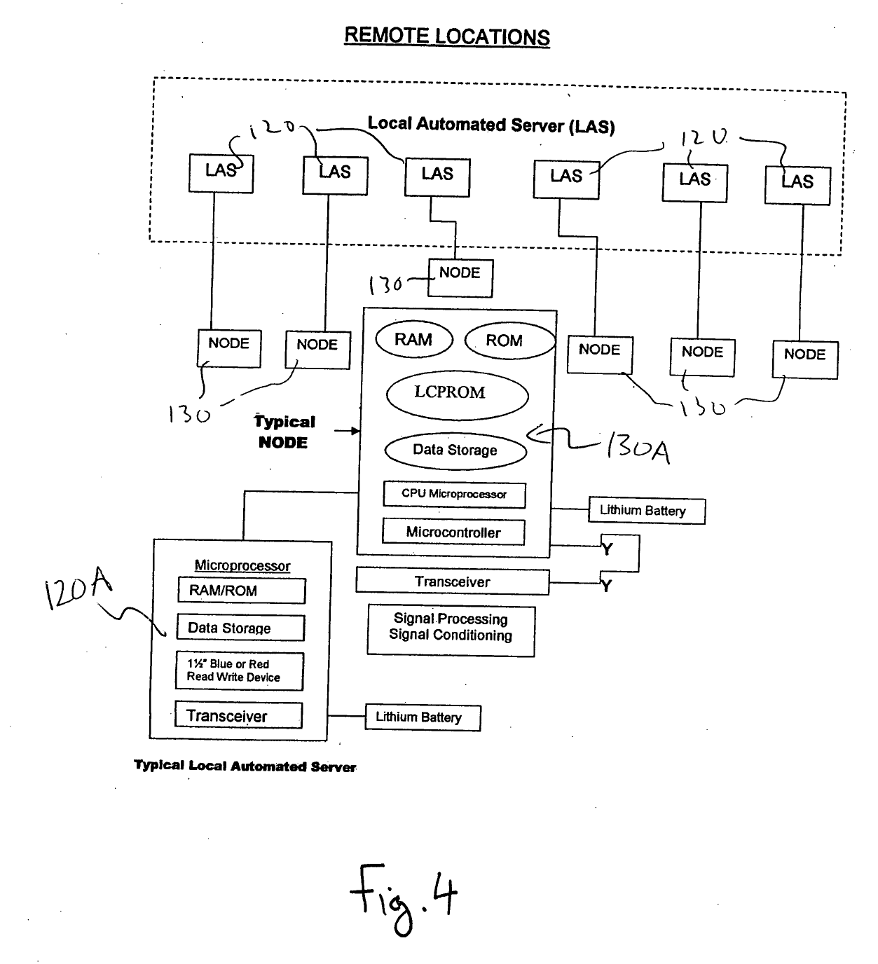

Referring now to Fig.4, remote sites include the LAS 120 connected to nodes 130. In the block diagram of FIG. 4, one node 130 is shown associated with each LAS 120, however, a LAS can be configured to handle multiple nodes using conventional multithread processing as known by those of skill in the art. A typical node and a typical LAS are shown in details 130A, 120A, respectively.

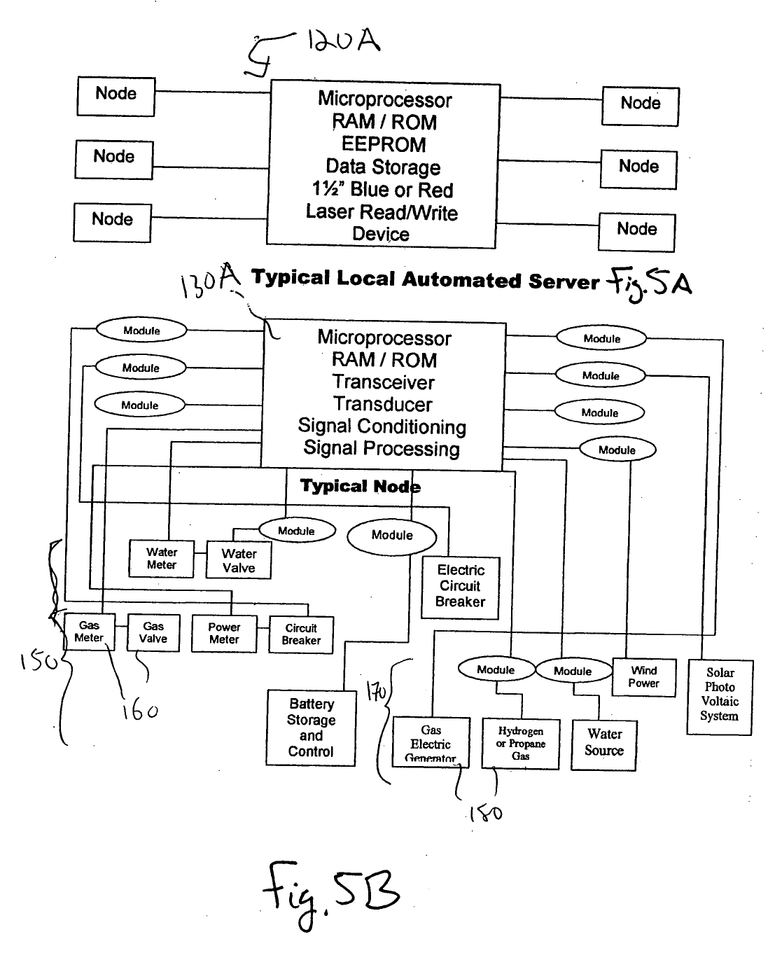

As shown in FIGS. 4 and 5A, The LAS 120A includes a microprocessor, RAM and ROM, data storage, a transceiver and optionally a read/write device such as a laser device or an EEPROM. The data storage enables the LAS to maintain information from one or more nodes based on multiple events for transfer to the CAS 110 in real time or batch mode.

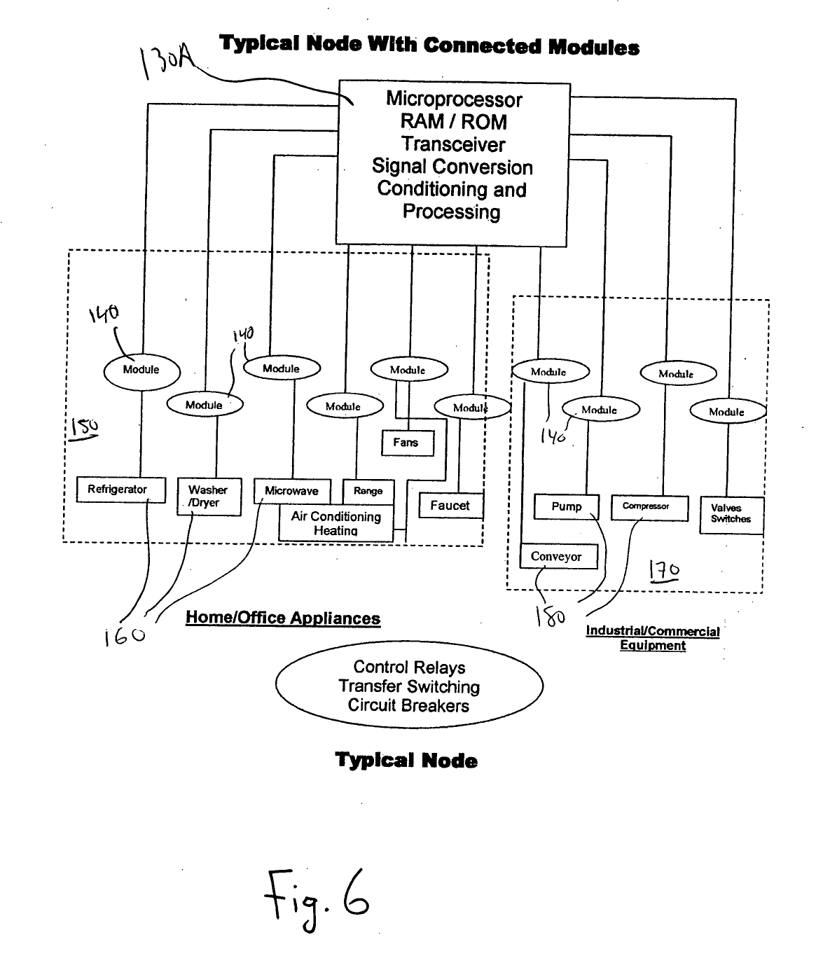

The node 130A shown in FIGS. 4 and 5B includes a microprocessor, RAM and ROM which are configured for singal processing and/or signal conditioning, and a transceiver for external communications, and typically also includes an LCPROM, data storage, and a microcontroller suitable, for example, for actuating a control relay, a transfer switch or a circuit breaker (see FIG. 6). The microcontroller includes a transducer when necessary to convert signals from an attached device 160, 180 such as an analog gas meter or valve. The node typically is provided with its own battery as a primary or back-up power supply. In FIG. 5B, a variety of devices 160, 180 are coupled to one or more nodes 130 through appropriate modules 140 (hardware or software) that permit data communication in either unidirectional or bidirectional manner, as is appropriate for each particular device. Certain devices 160 may be associated with home and office applications, such as gas meters and major appliances 150 (see FIG. 1), and other decies 180 may be associated with industrial and commercial applications such as gas electric equipment.

More particularly, and with reference now to FIG. 6, a typical node 130 is shown connected to modules 140, and each module is associated with a device 160, 180, for example, is in data communication with a particular device. The module 140 is in communication with a node 130 and provides data to the LAS 120 via its associated intelligent node.

The CAS and the LAS each execute software within their respective microprocessors that provide distributed control in the automated system. As such, the software running on each machine preferably is different, and generally complementary to one another, but can be redundant in part. The software is programmed to analyze information from prescribed devices and to report or execute control operations in response to that analysis. For example, if a condition is detected that is out of a prescribed range of operation, then a rule can cause a switch to open or operation of the device to alter or its power source to be swapped by sending control signals to nodes coupled to the device.

It should be understood that the LAS 120 can perform the following additional tasks beyond basic monitoring and control of devices 160, 180:

1. Communicates with the Worldwide Web

2. Communicates bi-directionally with CAS 110 to download as well as upload information, application programs and operating instructions.

3. Allows end user customers and clients/service providers to access critical information regarding the collected information via the web.

Optionally, centralized automated servers 110 can parallel as well as back up the functions of the remotely located automated servers. Further, the central automated server 110 may also provide for billing service and data storage. Still further, the central automated server allows the clients to obtain information provided by these servers via a fixed communication methodology. Still further, the central automated servers can accommodate a large variety of communication methodologies utilized by third party sensory devices and equipment that are located remotely in the field. Also, a large volume of data can be accepted and processed.

Some of the many features of the CASs 110 and LASs 120 may include:

1. Transaction processing.

2. Activity management of activity plans.

3. Alarm monitoring.

4. Execution of control commands to the end devices orequipment as a result of data collected from the system.

5. Anti prevention of tampering with equipment.

6. Outage monitoring of service and equipment.

7. Automated calling of clients that provides the main service and equipment.

8. Monitoring of earthquake data to determine if that data requires a command decision for the service provided.

9. A scheduler subsystem to control the time based execution of work from the services to appliance, meter reading devices or other equipment and devices downstream of the server.

10. Configurations to enable users to create insightful reports and identify trends. This allows users to truly understand the performance and characteristics of each location and compare it against one another.

11. In the case of automated utility meter information, each location could be each home or business electrical, gas and water characteristics as compared to others in the same type of location.

12. Providing open scalable architecture that ensures the flexibility to work in nearly any environment, while supporting a virtually unlimited number of devices distributed around the globe.

13. Extending the enterprise by integrating intelligent devices throughout the organization with strategic business system such as ERP, SCM ad CRM.

14. ERP, SCM and CPM are information technology (IT) business systems.

15. Assisting businesses to integrate the power of field devices into their business processes.

16. The platform from the servers can monitor and manage all aspects of a facility using one common infrastructure unlike point solutions that focus only one facet of facility management.

17. This platform makes it a universal solution for multi site enterprises.

For energy management, the following features are made practicable by the servers and nodes:

1. To know exactly what is driving energy consumption and confidently implementing changes that will provide hard cost savings.

2. Provide information or maintenance requirements to maintain efficient and effective operation of controlled devices.

Furthermore, the automated system provides for energy and environmental monitoring by performing the below listed functions:

1. Enabling the facilities and all the devices within them to manage themselves automatically and provide notification to facility managers where ever they may be.

2. Performing remote management, temperature monitoring predictive equipment failures and reporting out of normal conditions.

For security and access control, the automated system restricts access preferably only to authorized individuals and prevents theft with a few simple devices that plug into the communication network.

For scheduling and logging, the automated system further performs the following features:

1. Taps into valuable information locked within devices and uses this information to analyze what is really happening across all locations with

a. Real time information logging.

b. Date aggregation across all locations.

c. Trend reporting and analysis.

The invention ensures that customers have a safe and comfortable experience every time they visit the automated systems' locations.

The invention further promises to deliver innovative revenue generating services such as service and maintenance contracts as well as access to energy usage information.

In an exemplary embodiment, the present invention provides a remote automated system to monitor, read, and both control and switch liquids, gases, and electric power. As part of the remote automated system, an automated server system consisting of centralized automated servers and local automated severs; managing and facilitating the monitoring, reading, controlling and switching of all components of the system.

Furthermore, a networked node system interfaces directly with the devices that are to be monitored, read and controlled.

The system is preferably a true distributed system, which decentralizes the data gathering, signal conversion, signal conditioning and execution of control. The system augments a central hierarchal distributed environment with decentralized subsystems that can act as stand-alone units.

The present invention can be used in a variety of applications including Utility Meter Reading; Security, Safety and Fire Monitoring and Alarming; and Home, Business, Commercial and Industrial Automation.

In summary, one or more of the following items can apply to the present invention:

1. It comprises an automated system for monitoring, reading, controlling and switching gases, liquids and electric power.

2. The automated system comprises the following major components:

a. Centralize Automated Server (CAS)

b. Local Automated Server (LAS)

c. Remote Intelligent Nodes

d. Remotely Distributed Modules

e. Total System Software

3. The automated system as recited in 1 or 2 will gather information, store and process this information at the centralized as well as local automated servers.

4. A centralized located automated server system communicates with an interface unit, which is connected via metering devices to an appliance or any equipment that can be monitored and/or controlled.

5. A local automated server operates in conjunction with the centralized automated server as recited in 4, to monitor, read and control appliances and/or equipment.

6. An interface unit, converts real world analog signals into digital data and communicates with intelligent nodes. Said nodes and the interface units work together to read and analyze the medium(s). The information collected, such as flow, pressure, heating and cooling as well as a myriad of other data is used to affect various control functions to the connected appliances or equipment.

7. Each interface unit, node and modules are microprocessor based. The combination of the devices reads the real world signals; conditions these signals and uploads the converted digital data to the local automated sever as recited in 5. Analog-to-digital converters, digital-to analog converters and frequency-to-voltage converters as well as other subsystems are utilized in the conversion process. The location address for each node is a 48 bit long digital address to ensure that each customer have their own unique appliance or equipment address as well as a unique customer identification.

8. Each node as recited in 6 has ROM, RAM and EEPROM microprocessor memory chips. Data compression methods are used for the efficient utilization of solid-state memory.

9. The local sever as recited in 7 consist of a web based server with its own TCP/IP (Transmission Control Protocol/Internet Protocol) and a set of microprocessors chips. It also consist of a red or blue wavelength read/write 1.5 inch CD driver-control unit for gigabyte magnitudes of data storage, operating system programs and application programs.

10. Each node as recited in 8 will utilize peer-to-peer communication, whereby the appliance or equipment connected to the nodes can be enabled, disabled or otherwise controlled, so as to create a virtual power, gas, or liquid environment system when the medium is to be conserved and/or the medium's cost is to be minimized for cost savings.

11. The appliance or equipment's gas, liquid and electric power (via each integrated node) as recited in 10 can be automatically switched to a compatible medium of a similar kind to continue operation of the aforementioned appliances or equipment, all based upon pre-programmed instructions.

12. The electric power medium as recited in 11 can be switched from the normal electrical grid supply by a transfer switch incorporated in the power node device to transfer the power to be supplied by a solar photovoltaic system, a wind turbine generator system or a gas generator driven system. All systems incorporate a battery-charging backup.

13. The node for the electric power medium as recited in 12 will connect and interact with intelligent voltage and current devices. The voltage and current devices are based upon power metering Integrated Circuit (IC's), Chips and Rogowski Coils for current measurements. The metering IC's will monitor true reactive and apparent power.

14. The gas medium as recited in 11 can be switched from the normal gas supply by transfer valve switch sets, incorporated in the gas node device to transfer the gas supply to a hydrogen gas system, a propane gas system, or a bio-gas system source. In addition, the node consist of a MOSFET type solid state Pulse Width Modulated (PWM) and Field Effect Transistor controller (FET) circuit to operate the required compressor vane type pumping equipment.

15. The node for the gas medium as recited in 14 will connect and interact with intelligent non-invasive flow devices. The flow devices are based upon ultrasonic and magnetic flow transducers; which consist of micro controllers, memory chips and communication protocols as well as twisted pair low voltage wires, RF and power line communication capabilities. Further, communication from the gas node conversion device to the LAS or CAS can occur through the gas medium pipeline, utilizing the gas as the carrier for the radio frequency broadcast.

16. The liquid medium as recited in 11 can be switched from the normal liquid supply by transfer valve switch sets incorporated in the liquid node device, to transfer the liquid supply to an alternative liquid supply, such as a water well, tank or any naturally standing body of water (ocean, river, lake) source. In addition, this node consist of a Metal Oxide Field Effect Transistor (MOSFET) type solid state Pulse Width Modulated (PWM) and Field Effect Transistor (FET) controller circuit, to operate the required pumping equipment.

17. The node for the liquid medium as recited in 16 will connect and interact with intelligent non-invasive flow devices. The flow devices are based upon ultrasonic and magnetic flow transducers; which consist of micro controllers, memory chips and communication protocols as well as twisted pair low voltage wires, RF and power line communication capabilities. Further, communication from the liquid node conversion device to the LAS or CAS can occur through the liquid medium pipe. Further, communication from the gas node conversion device to the LAS or CAS can occur through the gas medium pipeline, utilizing the gas as the carrier for the radio frequency broadcast, utilizing the liquid as the carrier for the radio frequency broadcast.

18. A World Wide Web site will be accessible by either the end user customer or the client, which owns the medium. The web site will be accessible from the centralized automated sever system as recited in 2 and/or the local automated server system as recited in 5.

19. The automated system as recited in 1, 2, and 3 will incorporate a central and local automated sever system and consist of software to communicate between the central automated servers and local automated servers.

20. Software in the centralized servers will communicate with the application, data storage and data conversion programs distributed in the local automated servers, which are located at the premise of the end user customer's facility, homes and/or businesses. As referred to in 18, the end users and clients can locate information from any monitored equipment, meters and appliances via the internet connected servers.

21. The system as indicated in 1 and 2 is a true distributed computing network. Computing tasks are not just distributed at the central hierarchal location by several host, (which divides work among a number of host servers and executes control via these host servers), as defined by U.S. Pat. No. 6,088,659, (See Patent information on page 26 and 27) but are distributed at the source of the signal. Furthermore, all signal conditioning is completed at the source, thereby off-loading these tasks away from the centralized host servers.

22. The data repository, transactions and transaction processing are performed by the local automated servers. In the event that the local automated servers are somehow compromised, the centralized server hosts operates as a backup to the local server host. Moreover, the centralized severs can provide information to the clients, while the local servers can more easily convey its information to the end users (customers). The nodes as recited in 10 and 11 are accessed by both the centralized as well as the local servers.

23. The software of the centralized automated severs as recited in 20 enables load balancing, load shedding and scheduling; and assigns these task to the local automated servers via its node connections and communication network protocols.

24. The centralized automated servers as recited in 22 utilizes the data repository within an object oriented environment to access a relational database table mapping distributed in the centralized automated severs as well as the local automated severs. Furthermore, the centralized severs downloads activity plans to the distributed local severs and monitors said plans. The local servers at the node level, implements alarms, schedules and events.

25. The communication approach utilized by said system as recited in 21 consist of bi-directional communications. In this case, communications are initiated from either the remote site or the central station. The advantages of both inbound and outbound communications are incorporated in this system design. In the majority of cases, however the inbound function is used, thus reducing telephone charges. In addition, due to the decreased density of outbound traffic, telephone company switchgear and test trunk lines are minimized. Further, all communications utilizing the gas and/or liquid medium is also bidirectional communication.

26. Furthermore, as recited in 17, 18, and 20, the communication systems of the centralized automated servers and local automated servers as well as the communication between the nodes and the devices/modules (monitored and controlled by these nodes), are designed to utilize the following methods:

a. Power Line Carrier-Power line carrier communications take place over the same lines that deliver electricity.

b. Radio Frequency-Radio frequency or RF systems make use of small low power RF transmitters or transceivers located at the controller connected to a hand-held data terminal. Two of the more exotic approaches involve use of a cellular telephone network system and satellite communications. In addition, another exotic approach in the invention uses the liquid and gas medium, via their respective pipelines to transmit RF signals.

The mobile receiver approach suffers the disadvantage of being effectively unidirectional; thus, communication cannot be initiated from the utility's central office.

c. Cable Television Communication-This communication approach uses existing cable television lines to transmit data. Some tests have shown that this may be a cumbersome and expensive approach, but some municipal utilities that own cable systems are undertaking this type of communication. However, the limitations of this type of communication systems, are not configured to pass signals from the customer's site to a central facility. Future advances in cable will include bidirectional digital signal transmission and much wider bandwidth ultimately using fiber optics, at which point cable will be an ideal communications medium. The present invention will incorporate the future capability of bidirectional cable transmission.

d. Twisted Pair Low Voltage Wire-This form of communication utilizes low voltage small gauge wire for two-way communications. For the present invention, two pair wire will be used mainly for peer-to-peer node communication.

27. The present invention will integrate all of the different communication methods as described previously, so that a virtual seamless flow of information is created.

28. Wireless Fidelity (WI-FI) communications and chip sets will be used in conjunction with cellular and satellite communication methodologies to augment fixed wireless systems. WI-Fl systems will likely be owned by companies, municipalities and institutions as well as by the general public.

29. The WI-FL technology augments the services of cellular towers in areas known as “dead spots”. The present invention will furnish its own WI-Fl in those dead zones to facilitate wireless communications.

30. The invention will enable customers or third party control and service companies to communicate with the AMR system through the BACNET, MODBUS, LONWORKS and OVERLAY PROCESS CONTROL (OPC) communication protocols.

31. The invention will incorporate a hardware and software solution to enable the system described herein to seamlessly function with Control Company proprietary systems manufactured by such firms as Honeywell Corp.; Johnson Controls, Inc..; Seimens, Inc.; Staefa Landis and Gyr, Inc. as well as many other Control System Firms.

While the present invention has been described with respect to certain embodiments thereof, the invention is susceptible to implementation in other ways and manners which are still within the spirit of the invention. Accordingly, the invention is to be defined solely in respect of the recitations in the claims appended thereto and equivalents of the recitations therein.

I claim:

1. A distributed automated system for monitoring, control, or both of a device, comprising:
a centralized automated server (CAS);
one or more local automated servers (LAS) in data communication with the CAS, each LAS including a microprocessor and memory configured to analyze data provided thereto;
one or more intelligent nodes remote from each LAS;
a module associated with each intelligent node, the module being in communication with said node, the module interfacing with the device and providing data from the device to the LAS via a respective node; and
software executing on each of the CAS and the LAS, the software configured to store and process information from each node at one or more of the LAS and the CAS and to selectively execute a local control operation on the device via communication through the respective module and node.

2. The system of claim 1, wherein the modules convert analog signals from the intelligent nodes into digital data and communicate the digital data to the LAS.

3. The system of claim 1, wherein at least one node includes memory and is configured to compress data for efficient storage of information in the memory.

4. The system of claim 1, wherein the LAS comprises a web server configured to communicate using TCP/IP.

5. The system of claim 1, wherein the device comprises an appliance supplied by one of gas, liquid and electric power, wherein the software on the LAS is configured to prevent service disruption of the device by switching the supply to a compatible medium based upon pre-programmed instructions in the software.

6. The system of claim 5, wherein the pre-programmed instructions in the software are implemented free of influence of the CAS.

7. The system of claim 5, wherein the compatible medium is one of a solar photovoltaic system, a wind turbine generator system and a gas generator driven system.

8. The system of claim 1, wherein each module is configured to condition data from a respective device to thereby off-load that computational task from the LAS and the CAS so that the data provided to the LAS by the module is conditioned data.
